(19) United States
(12) Patent Application Publication
(10) Pub. No.: US 2023/0095676 A1
(43) Pub. Date: Mar. 30, 2023

(54) METHOD FOR MULTI-TASK-BASED PREDICTING MASSIVEUSER LOADS BASED ON MULTI-CHANNEL CONVOLUTIONAL NEURAL NETWORK

(71) Applicant: HOHAI UNIVERSITY, Nanjing (CN)

(72) Inventors: Haixiang ZANG, Nanjing (CN); Ruiqi XU, Nanjing (CN); Fengchun ZHANG, Nanjing (CN); Xin JIANG, Nanjing (CN); Zhinong WEI, Nanjing (CN); Guoqiang SUN, Nanjing (CN)

(21) Appl. No.: 17/953,517

(22) Filed: Sep. 27, 2022

(30) Foreign Application Priority Data
Sep. 27, 2021 (CN) 202111134821.0

(51) Int. Cl. G06N 3/06

(52) U.S. Cl. CPC G06N 3/06

(57) ABSTRACT

A method for multi-task-based predicting massive-user loads based on a multi-channel convolutional neural network, and belongs to the technical field of electric power systems. The method includes clustering all residential users into a plurality of clusters with different daily average electricity consumption modes by adopting an agglomerative hierarchical clustering method. Corresponding input data sets are constructed for various clusters by adopting a multi-channel-based multi-source input fusion method. Then, a multi-task-based load prediction model based on a convolutional neural network is established for each of the clusters. Load prediction values for different users in the corresponding cluster are output in parallel by each model to eventually obtain load prediction results of all of the residential users. In the present disclosure, the load predictions for all of the residential users are completed, the average prediction accuracy is improved, the number of modeling times and the accumulative operation time are greatly reduced.

### RELATED APPLICATIONS

The present application claims priority from Chinese Application Number 202111134821.0, filed Sep. 27, 2021, the disclosure of which is hereby incorporated by reference herein in its entirety.

### TECHNICAL FIELD

The present disclosure belongs to the technical field of electric power systems, and in particular relates to a method for multi-task-based predicting massive-user loads based on a multi-channel convolutional neural network.

### BACKGROUND

With the development of electric power systems, a load prediction has permanently played an important role in maintaining the balance of supply and demand and ensuring the safe, stable and economical operation of the electric power grid. With the continuous advancement on the reform of the electricity sales side, a diversified pattern of electric power sales entities will eventually be formed, and electricity sales enterprises have to provide personalized value-added services to improve the competitiveness of their own electricity sales services. The traditional prediction technology for system-level loads can no longer satisfy the technical requirements for the electric power enterprises in the future, and the prediction technology for user-level loads will become a precondition and foundation for the electric power sales enterprises to provide personalized energy services for target customers. An accurate user load prediction can improve the marketing levels of the electric power enterprises, and avoid assessment deviations. As an important part for constructing the smart electric power grid, the advanced measurement system, on one hand, provides a massive data basis for the analysis on the user's electricity behavior characteristics, and on the other hand, it also brings challenges on efficient processing and effective application of the massive data. At present, the user load prediction technology based on massive data is one of the research hotspots in the field of predicting electric power systems.

So far, scholars from China and abroad have produced rich results from theoretical research and practical application during the research process. Most of the load prediction technologies focus on system-level or region-level loads. Compared with aggregated loads such as system-level or region-level loads, the user-level loads are mostly affected by their own electric power consumption behaviors, and have stronger uncertainty and individual randomness, which reduces the measurability and increases the difficulty on prediction. It is difficult for the traditional prediction methods for the aggregated loads to ensure their applicability and prediction accuracy in the user-level load prediction, where the prediction methods need to be changed accordingly. At present, in the research on the methods for predicting the user-level loads, the load prediction method based on a single task is more common. However, with the gradual improvement on the advanced measurement systems, the user-level load data will further present the characteristics of large quantity and various types in the future. Apparently, in the case of massive-user scenarios, if the single-task-based prediction method is adopted to model for each user one by one, it will consume excessive computing and time resources. When the number of users is larger, the operation efficiency will become an important criteria that can not be ignored besides the accuracy when evaluating the performance of the prediction methods. In addition, the single-task-based prediction method also has the problem of ignoring the correlations among different users, and the correlations among the massive data has not been fully mined and deeply studied in the user-level load prediction. Therefore, it is urgent to provide a load prediction method suitable for massive users, which can learn the correlations among user loads and take into account of both the prediction accuracy and the operation efficiency.

### SUMMARY

The objectives of the present disclosure are as follows. In the present disclosure, in view of the deficiencies of the methods for predicting the massive-user loads at present, including problems such as a lower operation efficiency, a lower prediction accuracy, and a failure to consider the load correlations among different users, a method for multi-task-based predicting massive-user loads based on a multi-channel convolutional neural network is provided, which learns the load correlations among residential users with similar electricity consumption modes based on a clustering technology and a multi-task-based learning strategy, so as to improve both the average prediction accuracy and the overall operation efficiency.

The technical solutions are as follows. The present disclosure provides a method for multi-task-based predicting massive-user loads based on a multi-channel convolutional neural network. The method includes the following steps.
(1) All residential users are clustered into a plurality of clusters with different daily average electricity consumption modes by adopting an agglomerative hierarchical clustering method.
(2) Corresponding input data sets are constructed for various clusters by adopting a multi-channel-based multi-source input fusion method.
(3) A multi-task-based load prediction model based on a convolutional neural network is established for each of the clusters, load prediction values for different users in a corresponding cluster are output in parallel by each model to eventually obtain load prediction results for all of the residential users.

Furthermore, in Step (1), all residential users are clustered into a plurality of clusters with different daily average electricity consumption modes by adopting an agglomerative hierarchical clustering method. The agglomerative hierarchical clustering method is as follows.

2.1 A matrix F including clustering features of N samples is constructed,

F=[f₁,f₂, . . . , f_{N}]^{T},

where fⱼ is a clustering feature of the j-th sample, j represents serial numbers of samples, T represents transposition, and j=1,2, . . . , N.

2.2 Proximities between each two clusters are calculated by taking each sample as one cluster to obtain an initial proximity matrix P, wherein a calculation formula of an element p_{k,g} in the k-th row and the g-th column is:

P={p_{k,g}}k=1, . . . N, g=1, . . . N, and

p_{k,g}=dis (fₖ,f_{g})k≠g,

where dis(*) represents a calculation rule for the proximity of two clusters; both k and g represent serial numbers of the clusters, and fk and f_{g} are clustering features of the k-th and g-th clusters, respectively.

2.3 Two clusters with the highest proximity are merged as a new cluster and the proximity matrix P is updated.

2.4 Step 2.3 is repeated until the total number of the clusters is 1 or a stopping condition is reached.

Furthermore, in Step (2), corresponding input data sets are constructed for various clusters by adopting a multi-channel-based multi-source input fusion method. The multi-channel-based multi-source input fusion method includes as follows.

3.1 A single-user time sequence input is reconstructed. A historical load sequence of a resident user over the week from the day 8 days before the time to be predicted to the previous day of the time to be predicted is reconstructed into a two-dimensional feature map with 7 rows and 24 columns, wherein each row corresponds to daily loads for different dates and each column corresponds to loads of a specific hour on different dates.

3.2 Two-dimensional feature maps of different users in the same cluster are fused by utilizing a channel dimension. The two-dimensional feature maps corresponding to the different users in the same cluster are transmitted to different channels in inputs of the convolutional neural network, wherein data on a single channel is a two-dimensional feature map of one user. The feature maps of the different users in the same cluster are fused by utilizing the channel dimension, and the fused feature map is taken as an input of a feature sharing layer in the convolutional neural network.

In Step (3), the multi-task-based load prediction model based on the convolutional neural network is established for each of the clusters. The load prediction values for different users in the corresponding cluster are output in parallel by each model to eventually obtain the load prediction results of all of the residential users, and the multi-task-based load prediction model based on the convolutional neural network is as follows.

4.1 Load predictions for the different residential users in the same cluster are taken as gdifferent tasks, and a multi-task-based learning strategy is implemented for each cluster in assistance with learning correlations and differences among the loads of the different residential users. The calculation process of a loss function in the multi-task-based learning strategy is specifically as follows.

It is assumed that multi-task-based learning includes V tasks in total, an input and output data set corresponding to each task is {xᵥ, yᵥ}, v=1, 2, . . . V, and then all of the input data sets are:

X={x₁, . . . , xᵥ, . . . x_{V}}.

An output of a prediction model corresponding to the v-th task is defined as:

y^{v}=u^{v}(X;θhu sha,θ^{v}),

where u^{v} represents a mapping function of the prediction model corresponding to the v-th task, θ^{sha} is a parameter for the feature sharing layer, and θ^{v} is a parameter for the v-th specific task layer, v=1,2, . . . V.

A joint learning is conducted on related tasks for a plurality of tasks in a hard sharing mechanism, and network parameters are trained by minimizing an overall loss function, wherein a calculation of an overall optimization loss function is as follows:

$$Loss = {\sum }_{v = 1}^{V} {α}_{v} loss ( {u}^{v} ( {θ}^{sha} , {θ}^{v} ) , {y}^{v} ) ,$$

where loss(⋅) represents a loss function for the tasks; and αᵥ is a weight coefficient corresponding to each of the tasks.

4.2 The convolutional neural network is taken as a feature sharing layer for a multi-task-based learning to extract correlations among different tasks. A calculation process of the convolutional neural network is specifically as follows.

4.2.1 Calculations in the convolutional layers are conducted. It is assumed that the number of convolution kernels in the a-th convolutional layer is C^{a}, and then a set MAP^{a} of output feature maps in the layer is:

$${MAP}^{a} = \{ {map}_{e}^{a} \} = \{ {f}_{con} ( {\sum }_{r ∈ {C}^{a - 1}} {map}_{r}^{a - 1} * {w}_{re}^{a} + {b}_{e}^{a} ) \} ,$$

where mapₑ^{a} represents an output feature map corresponding to the e-th convolution kernel in the a-th convolutional layer, mapᵣ^{a-1} represents the r-th output feature map in the (a−1)-th layer, C^{a-1} is the number of the output feature maps in the (a−1)-th layer, that is, the number of channels included in input data of the a-th convolutional layer, wᵣₑ^{a} is a kernel parameter for the e-th convolution kernel in the a-th convolutional layer corresponding to the r-th output feature map in a previous layer of the a-th convolutional layer, bₑ^{a} is a bias in the a-th convolutional layer corresponding to the e-th output feature map, and f_{con}(⋅) represents an activation function in the convolutional neural network.

4.2.2 A calculation in a maximum pooling layer is conducted, which is specifically as follows:

F_{down}(mapₑ^{a})=max{pix_{e,1}^{a},pix_{e,2}^{a}, . . . ,pix_{e,n}_{ₑ}_{^{a}}^{a}}, poolₑ^{a+1}=fₚₒₒₗ(βₑ^{a+1}F_{down}(mapₑ^{a})+bₑ^{a+1}), and

e=1,2, . . . ,C^{a},

where F_{down} represents a downsampling function in the maximum pooling layer, C^{a} represents the number of channels, mapₑ^{a} represents the output feature map in the a-th convolutional layer corresponding to the e-th convolution kernel, that is, a feature map in an input of the (a+1)-th pooling layer corresponding to the e-th channel, pix_{e,z}^{a} is the z-th pixel in the feature map, z=1,2, . . . , nₑ^{a+1}, nₑ^{a+1} is the total number of pixels corresponding to the feature map, poolₑ^{a+1} represents an output feature map in the (a+1)-th pooling layer corresponding to the e-th channel, βₑ^{a+1} and bₑ^{a+1} are a multiplicative bias and an additive bias in the output feature map, and f_{con}(⋅) is an activation function in the pooling layer.

4.3 The convolutional neural network is taken as the feature sharing layer to learn shared information representations among the different users, wherein a model for multi-task-based predicting the massive-user loads based on the multi-channel convolutional neural network mainly includes the feature sharing layer and specific task layers. The bottom portion of the feature sharing layer is formed by alternately connecting two convolutional layers with two pooling layers, and then a flattened result is input into a fully connected layer in the top portion to extract shared features, and transmit the shared features to each of the specific task layers. The specific task layers are configured to extract unique features of each of the users, each of which is specifically formed by a feature extraction enhancement channel, a Concatenate layer and the fully connected layer. The feature extraction enhancement channel is formed by a single fully connected layer, which is configured to extract features from a historical load time sequence of each of the users, to input the extracted features and shared features into the Concatenate layer for fusion. The load prediction values of all of the users in the same cluster are output in parallel after processing by the fully connected layer.

In the present disclosure, firstly, all residential users are clustered into a plurality of clusters with different daily average electricity consumption modes by adopting an agglomerative hierarchical clustering method. Secondly, corresponding input data sets are constructed for various clusters by adopting a multi-channel-based multi-source input fusion method. Then, a multi-task-based load prediction model based on a convolutional neural network is established for each of the clusters. Load prediction values for different users in a corresponding cluster are output in parallel by each model to eventually obtain load prediction results of all of the residential users.

The beneficial effects are as follows. Compared with the prior art, in the present disclosure, realized is a load prediction technology that is suitable for scenarios of predicting massive-user loads and takes into account of both the average prediction accuracy and the overall operation efficiency. Based on the agglomerative hierarchical clustering method, massive users are clustered into a plurality of clusters with different daily average electricity consumption modes, which significantly reduces the total number of modeling times. Moreover, a multi-task-based prediction model based on a multi-channel convolutional neural network is established for each cluster, which is used to extract the shared features and the different features among different users in the same cluster in assistance with better learning individual users, thereby improving the average prediction accuracy. In addition, the load prediction values for a plurality of users can be output in parallel by one single model, which has a wider output adaptation range, stronger model generalization ability, and shorter cumulative time to complete the load prediction tasks of all users, thereby further improving the overall operation efficiency and achieving stronger engineering application value and potential. The present disclosure can provide guidance for electric power enterprises to carry out personalized value-added services, which facilitates to improve their marketing levels, and can provide reference for formulating demand response strategies, thereby further ensuring the economical operation of the electric power systems.

### BRIEF DESCRIPTION OF THE DRAWINGS

FIG. 1 illustrates a schematic flowchart of a method for multi-task-based predicting massive-user loads based on a multi-channel convolutional neural network according to the present disclosure.

FIG. 2 illustrates a schematic diagram of a multi-channel-based multi-source input fusion method according to the present disclosure.

FIG. 3 illustrates a schematic diagram of a model for multi-task-based predicting loads based on a multi-channel convolutional neural network adopted by the present disclosure.

FIGS. 4(a)-4(d) illustrates a presentation diagram of an eventual prediction result using the provided method in an embodiment of the present disclosure.

### DETAILED DESCRIPTION OF THE EMBODIMENTS

The present disclosure will be further clarified below in combination with specific embodiments, and it should be understood that these embodiments are only used to illustrate the present disclosure and not to limit the scope of the present disclosure. After reading the present disclosure, modifications of various equivalent forms in the present disclosure by those skilled in the art all fall within the scope defined by the appended claims of the present disclosure.

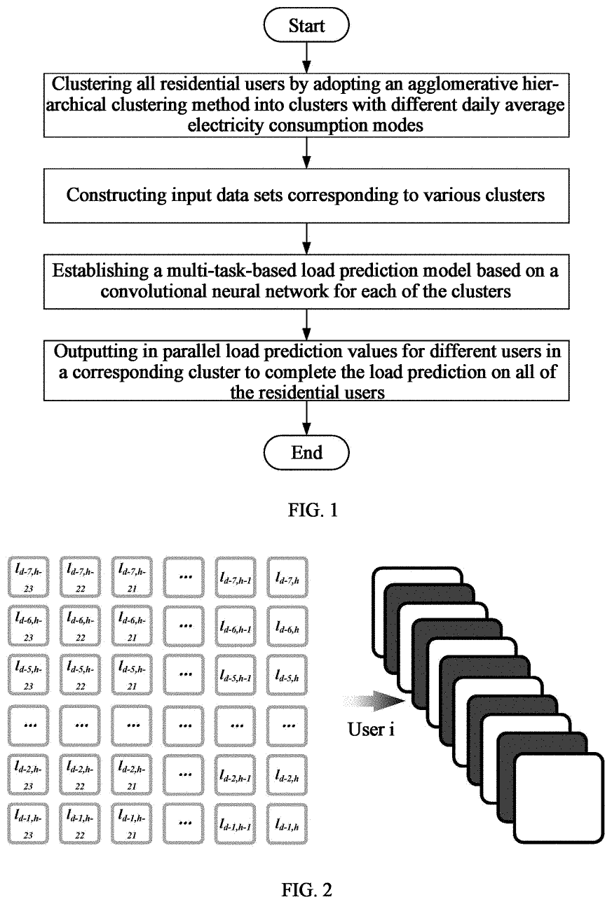

The present disclosure provides a method for multi-task-based predicting massive-user loads based on a multi-channel convolutional neural network. As illustrated in FIG. 1, the method includes the following steps.
(1) All residential users are clustered into a plurality of clusters with different daily average electricity consumption modes by adopting an agglomerative hierarchical clustering method.
(2) Corresponding input data sets are constructed for various clusters by adopting a multi-channel-based multi-source input fusion method.
(3) A multi-task-based load prediction model based on a convolutional neural network is established for each of the clusters, load prediction values for different users in a corresponding cluster are output in parallel by each model to eventually obtain load prediction results of all of the residential users.

The specific implementation processes in predicting the loads of massive residential users by using the method of the present disclosure will be described in detail below with reference to the specific embodiments. Taking the residential user data obtained from 805 residential users in total in the user behavior test for intelligently metering the electric power, which is initiated by the Irish Energy Code Commission, as an example, in which each user includes the historical load data sampled every half an hour from Jul. 14, 2009 to Dec. 31, 2010, the load values at each of the o'clock time points are taken as points per hour to form the load data. The resident loads in 24 hours are predicted in advance. The test sets include the data of the last weeks per month, the rest of which are taken as the training sets.

In Step (1), all residential users are clustered into a plurality of clusters with different daily average electricity consumption modes by adopting an agglomerative hierarchical clustering method. The agglomerative hierarchical clustering method is as follows.

2.1 The m-dimensional daily average load vector fⱼ is taken as the clustering feature of each of the resident users, and a matrix F including clustering features of N samples is constructed as follows:

$$F = {[ {f}_{1} , {f}_{2} , … , {f}_{N} ]}^{T} , {f}_{j} = {[ {o}_{j}^{1} , {o}_{j}^{2} , … , {o}_{j}^{m} ]}^{T} , \\ j = 1 , 2 , … , N , and {o}_{j}^{h} = \frac{1}{D} {\sum }_{d = 1}^{D} {l}_{j}^{d , h} , h = 1 , 2 , … , m ,$$

where N is the total number of resident users, that is, the number of samples; fⱼ is a daily average load vector of the j-th user, that is, the clustering feature of each sample; D is the total number of days of the load data; m is the dimension number of the daily average load vector, which is determined by the resolution of the load data, where m is taken as 24 in the present disclosure; oⱼ^{h} represents the value for the h-th dimension of the daily average load vector corresponding to the j-th user; lⱼ^{d,h} represents a historical load value for the j-th user at the h-th hour on the d-th day; and T represents the transposition.

2.2 Proximities between each two clusters are calculated by taking each sample (that is, a user) as a cluster respectively to obtain an initial proximity matrix P. The Euclidean distance is taken as the proximity calculation rule in the present disclosure, wherein a calculation formula of an element p_{k,g} in the k-th row and the g-th column is:

$$P = \{ {p}_{k , g} \} k = 1 , … N , g = 1 , … , N , \\ and {p}_{k , g} = dis ( {f}_{k} , {f}_{g} ) = \sqrt{{\sum }_{h = 1}^{m} {( {o}_{k}^{h} - {o}_{g}^{h} )}^{2}} k \neq g ,$$

where dis(⋅) represents a calculation rule for the proximity of the two clusters; both k and g represent serial numbers of the clusters, and fk and f_{g} are clustering features of the k-th and g-th clusters, respectively.

2.3 Two clusters with the highest proximity are merged, that is, the two clusters with the closest distance therebetween are merged in the present disclosure as a new cluster, and the proximity matrix P is updated. In the present disclosure, a sum of squares of deviations (Ward) method is adopted to calculate the proximities among clusters. The increment Δ ESS of the sum of squared deviation caused by the current mergence of each two clusters Cᵢ and Cⱼ is calculated, and only the two clusters corresponding to the smallest increment of the sum of squared deviation are merged into a new cluster.

Taking the sum of squared deviation of the cluster Cᵢ as an example, the calculation formula thereof is as follows:

$$ESS ( {C}_{i} , {μ}_{i} ) = {\sum }_{q ∈ {C}_{i}} {f}_{q}^{2} - \frac{1}{{Q}_{i}} {( {\sum }_{q ∈ {C}_{i}} {f}_{q} )}^{2} ,$$

where μᵢ represents the center of the cluster Cᵢ; and Qᵢ represents the number of users included in the cluster Cᵢ.

The formula for calculating the increment of the sum of squared deviations caused by merging clusters Cᵢ and Cⱼ is as follows:

ΔESS=ESS(Cᵢ∪Cⱼ,μ_{i∪j})-ESS(Cᵢ,μᵢ)-ESS(Cⱼ,μⱼ),

where μᵢ, μⱼ and μ_{i∪j} represent the centers of cluster Cᵢ, cluster Cⱼ and new cluster Cᵢ∪Cⱼ, respectively.

2.4 Step 2.3 is repeated until the total number of clusters is 1 or a stopping condition is reached. In the present disclosure, the 805 resident users are clustered into 22 classes.

In Step (2), corresponding input data sets are constructed for various clusters by adopting a multi-channel-based multi-source input fusion method, as illustrated in FIG. 2. The multi-channel-based multi-source input fusion method specifically includes the followings.

3.1 A single-user time sequence input is reconstructed. A historical load sequence of a residential user over the week from the day 8 days before the time to be predicted to the previous day at the time to be predicted is reconstructed into a two-dimensional feature map with 7 rows and 24 columns, wherein each row corresponds to daily loads for different dates and each column corresponds to loads of a specific hour on different dates.

3.2 Two-dimensional feature maps of different users in the same cluster are fused by utilizing a channel dimension. The two-dimensional feature maps corresponding to the different users in the same cluster are transmitted to different channels in inputs of the convolutional neural network, wherein data on a single channel is a two-dimensional feature map of one user. The feature maps of the different users in the same cluster are fused by utilizing the channel dimension, and the fused feature map is taken as an input of a feature sharing layer in the convolutional neural network.

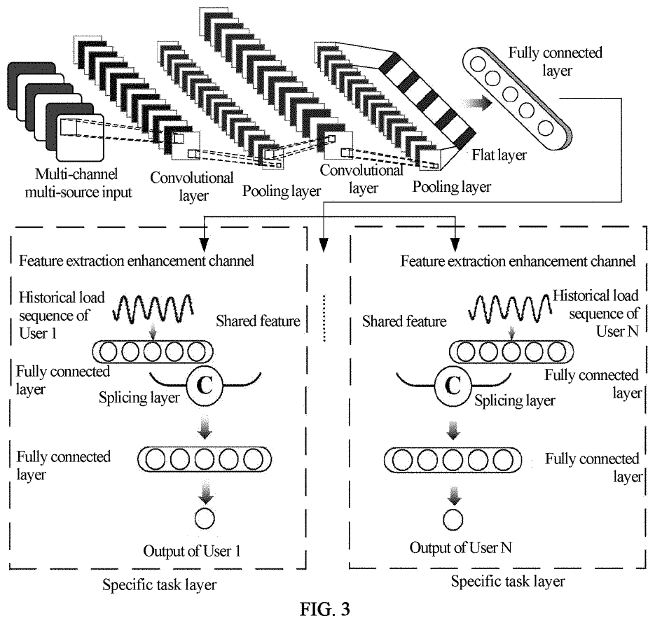

In Step (3), a multi-task-based load prediction model based on the convolutional neural network is established for each of the clusters, as illustrated in FIG. 3. The load prediction values for different users in the corresponding cluster are output in parallel by each model to eventually obtain load prediction results of all of the residential users, and the multi-task-based load prediction model based on the convolutional neural network is as follows.

4.1 Load predictions for the different residential users in the same cluster are taken as different tasks, and a multi-task-based learning strategy is implemented for each cluster in assistance with learning correlations and differences among the loads of the different residential users. A calculation process of a loss function in the multi-task-based learning strategy is specifically as follows.

It is assumed that multi-task-based learning includes V tasks in total, an input and output data set corresponding to each task is {xᵥ, yᵥ}, v=1, 2, . . . V, and then all of the input data sets are:

X={x₁, . . . ,xᵥ, . . . x_{V}}

An output of the prediction model corresponding to the v-th task is defined as:

y^{v}=u^{v}(X;θ^{sha},θ^{v}),

where u^{v} represents a mapping function of the prediction model corresponding to the v-th task, θ^{sha} is a parameter for the feature sharing layer, and θ^{v} is a parameter for the v-th specific task layer, v=1,2, . . . V.

A joint learning is conducted on related tasks for a plurality of tasks in a hard sharing mechanism, and network parameters are trained by minimizing an overall loss function, wherein a calculation of an overall optimization loss function is as follows:

$$Loss = {\sum }_{v = 1}^{V} {α}_{v} loss ( {u}^{v} ( {θ}^{sha} , {θ}^{v} ) , {y}^{v} ) ,$$

where loss(⋅) represents a loss function for the tasks; and αᵥ is a weight coefficient corresponding to each of the tasks.

4.2 The convolutional neural network is taken as a feature sharing layer for a multi-task-based learning to extract correlations among different tasks. A calculation process of the convolutional neural network is specifically as follows.

4.2.1 Calculations in the convolutional layers are conducted. It is assumed that the number of convolution kernels in the a-th convolutional layer is C^{a}, and then a set MAP^{a} of output feature maps in the layer is:

$${MAP}^{a} = \{ {map}_{e}^{a} \} = \{ {f}_{con} ( {\sum }_{r ∈ {C}^{a - 1}} {map}_{r}^{a - 1} * {w}_{re}^{a} + {b}_{e}^{a} ) \} ,$$

where mapₑ^{a} represents an output feature map corresponding to the e-th convolution kernel in the a-th convolutional layer, mapᵣ^{a-1} represents the r-th output feature map in the (a−1)-th layer, C^{a-1} is the number of the output feature maps in the (a−1)-th layer, that is, the number of channels included in input data of the a-th convolutional layer, wᵣₑ^{a} is a kernel parameter for the e-th convolution kernel in the a-th convolutional layer corresponding to the r-th output feature map in a previous layer of the a-th convolutional layer, bₑ^{a} is a bias in the a-th convolutional layer corresponding to the e-th output feature map, and f_{con}(⋅) represents an activation function in the convolutional neural network.

4.2.2 A calculation in a maximum pooling layer is conducted, which is specifically as follows:

F_{down}(mapₑ^{a})=max {pix_{e,1}^{a},pix_{e,2}^{a}, . . . ,pix_{e,n}_{ₑ}_{^{a}}^{a}}, poolₑ^{a+1}=fₚₒₒₗ(βₑ^{a+1}F_{down}(mapₑ^{a})+bₑ^{a+1}),and

e=1,2, . . . ,C^{a},

where F_{down} represents a downsampling function in the maximum pooling layer, C^{a} represents the number of channels, mapₑ^{a} represents the output feature map in the a-th convolutional layer corresponding to the e-th convolution kernel, that is, a feature map in an input of the (a+1)-th pooling layer corresponding to the e-th channel, pix_{e,z}^{a} is the z-th pixel in the feature map, z=1,2, . . . , nₑ^{a}, nₑ^{a+1} is the total number of pixels corresponding to the feature map, poolₑ^{a+1} represents an output feature map in the (a+1)-th pooling layer corresponding to the e-th channel, βₑ^{a+1} and bₑ^{a+1} are a multiplicative bias and an additive bias in the output feature map, and f_{con}(⋅) is an activation function in the pooling layer.

4.3 The convolutional neural network is taken as the feature sharing layer to learn shared information representations among the different users, wherein a model for multi-task-based predicting the massive-user loads based on the multi-channel convolutional neural network mainly includes the feature sharing layer and specific task layers. The bottom portion of the feature sharing layer is formed by alternately connecting two convolutional layers with two pooling layers, and then a flattened result is input into a fully connected layer in the top portion to extract shared features, and transmit the shared features to each of the specific task layers. The specific task layers are configured to extract unique features of each of the users, each of which is specifically formed by a feature extraction enhancement channel, a Concatenate layer and the fully connected layer. The feature extraction enhancement channel is formed by a single fully connected layer, which is configured to extract features from a historical load time sequence of each of the users, to input the extracted features and shared features into the Concatenate layer for fusion. The load prediction values of all of the users in the same cluster are output in parallel after processing by the fully connected layer. The prediction results of the method provided in the present disclosure are as shown in Table 1.

Since the true load values of 0 of the residential users exist in the data set, two error indicators, RMSE and MAE, are selected to measure the average prediction accuracy based on this method for the massive users. The values of the above two error indicators are averaged for all residential users in the present disclosure, and the calculation formulas are as follows:

$${RMSE}_{mean} = \frac{1}{U} {\sum }_{i = 1}^{U} \sqrt{\frac{1}{{N}_{i}} {\sum }_{j = 1}^{{N}_{i}} {( {\hat{y}}_{j}^{i} - {y}_{j}^{i} )}^{2}} , \\ and {MAE}_{mean} = \frac{1}{U} {\sum }_{i = 1}^{U} \frac{1}{{N}_{i}} {\sum }_{j = 1}^{{N}_{i}} \vert {\hat{y}}_{j}^{i} - {y}_{j}^{i} \vert ,$$

where U is the total number of the residential users; Nᵢ is the number of samples included in the i-th user; ŷⱼⁱ is the load prediction value for the j-th sample of the i-th user; and yⱼⁱ is the true load value for the j-th sample of the i-th user.

In addition, three other multi-task-based prediction methods are selected as the benchmark methods in the present disclosure. In Method One, the multi-channel multi-source input fusion method in the provided method is replaced with the traditional multi-task-based learning input construction method. In Method Two, the feature extraction enhancement channels at the output terminals in the provided method are removed. In Method Three, the multi-source input fusion method in the provided method is replaced with the traditional multi-task-based learning input construction method, while the feature extraction enhancement channels at the output terminals in the provided method are removed. In such a way, the effectiveness of the multi-channel-based multi-source input fusion method and the feature extraction enhancement channel in improving the average prediction accuracy is verified by users respectively. In addition, three single-task prediction methods based on DNN, CNN, and LSTM, respectively, namely, Method Four, Method Five, and Method Six, are selected as benchmark methods to highlight the advantages of the multi-task-based learning in term of average prediction accuracy and overall operation efficiency. The load prediction results of the six benchmark prediction methods are as shown in Table 1.

TABLE 1
Comparison of the prediction results between the provided
method and six benchmark prediction methods

| | | | | Cumulative | Cumulative | Total |
|---|---|---|---|---|---|---|
| Method | Prediction | RMS Emean | MAEmean | training time | testing time | Duration |
| Types | Methods | (Kwh) | (Kwh) | (s) | (s) | (s) |
| Mulit-task | The provided | 0.1787 | 0.1327 | 2388 | 38 | 2426 |
| | Method | | | | | |
| | Method One | 0.1880 | 0.1410 | 2104 | 40 | 2144 |
| | Method Two | 0.1848 | 0.1378 | 1306 | 24 | 1330 |
| | Method Three | 0.2112 | 0.1670 | 2147 | 39 | 2186 |
| Single-task | Method Four | 0.1833 | 0.1368 | 3496 | 67 | 3563 |
| | Method Five | 0.1882 | 0.1411 | 6260 | 113 | 6373 |
| | Method Six | 0.1918 | 0.1463 | 402493 | 12002 | 414495 |

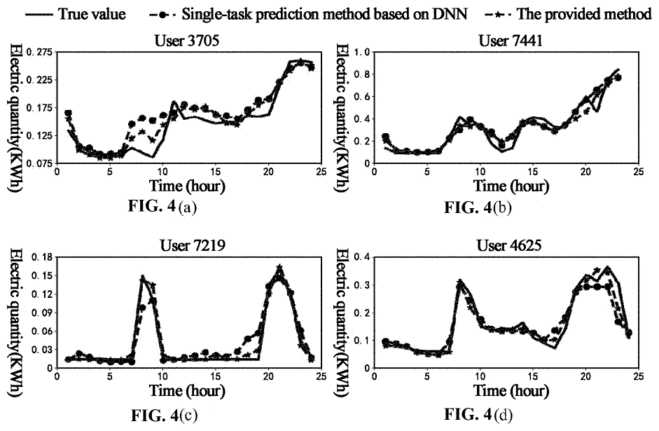

It can be seen from Table 1 that the cumulative time spent on the four multi-task-based load prediction methods to complete the load prediction tasks of all users is significantly less than that of the three single-task-based benchmark prediction methods, which reflects the significant advantage of the multi-task-based learning strategy in improving the overall operation efficiency. The average values for the error indicators of Benchmark Method Three is larger than those of the single-task learning prediction method based on DNN, which indicates that the multi-task-based learning benchmark methods using the traditional multi-task-based learning input construction method and output structure cannot improve the average prediction accuracy in the scenarios of increasing massive users. If the input thereof is improved (compared with Method Two) by the multi-channel-based multi-source input fusion method and the output thereof is improved (compared with method One) by adding the feature extraction enhancement channel, the average prediction accuracy can be improved. If the provided solutions are adopted, that is, the input and output of traditional multi-task-based learning are improved at the same time, the prediction accuracy can reach the highest effectiveness, the cumulative operation time is approximate to that in Method Three, and the total duration is proper among the six benchmark prediction methods. The comparison chart of the prediction curves of the solutions provided in the present disclosure and the single-task prediction method based on DNN is as illustrated in FIGS. 4(a)-4(d), which illustrates the daily load prediction results of four different residential users respectively. It can be seen from FIG. 4(a) and FIG. 4(b) that, compared with the single-task load prediction method based on DNN, the prediction curves of User 3705 and User 7441 based on the provided solutions fit the curve of the true load value better in term of fitting the overall change trend. In FIG. 4(c) and FIG. 4(d), the load prediction curves of User 7219 and User 4625 obtained based on the provided solutions can not only fit the overall change trend better, but also predict the load values at the local limit points more accurately, which verifies again the effectiveness of the method provided in the present disclosure in improving the average prediction accuracy on the residential user loads.

To sum up, the solutions provided in the present disclosure can be applied to scenarios of predicting massive-user loads to handle the user-level load prediction tasks on large scales. Compared with the single-task-based load prediction methods, the time resources are significantly reduced by the solutions provided in the present disclosure. Compared with the load prediction methods based on the traditional multi-task-based learning structure, the average prediction accuracy is improved, thereby realizing the balance between prediction accuracy and operation efficiency, and obtaining a stronger engineering application value and potential, which can provide electric power enterprises a reference basis to provide personalized value-added services for electricity sales, play an important guiding role in improving the marketing levels of electric power enterprises and avoiding assessment deviations, and which can provide an effective reference for the formulation of demand response plans, and facilitates the economic operation of the electric power grid.

1-6. (canceled)

7. A method for multi-task-based predicting massive-user loads based on a multi-channel convolutional neural network, wherein the method comprises following steps:
(1) clustering, by adopting an agglomerative hierarchical clustering method, all residential users into a plurality of clusters with different daily average electricity consumption modes;
wherein, the agglomerative hierarchical clustering method is as follows:
2.1 constructing a matrix F including clustering features of N samples:
F=[f₁,f₂, . . . , f_{N}]^{T},
where fⱼ is a clustering feature of a j-th sample, j represents a serial number of the j-th sample, T represents transposition, and j=1,2, . . . ,N;
2.2 calculating, by taking each sample as a cluster, proximities between each two clusters to obtain an initial proximity matrix P, wherein a calculation formula of an element p_{k,g} in a k-th row and a g-th column is:
P={p_{k,g}}k=1, . . . N, g=1, . . . N, and
p_{k,g}=dis (fₖ,f_{g})k≠g,
where dis (⋅) represents a calculation rule for a proximity of two clusters; both k and g represent serial numbers of the two clusters, and fₖ and f_{g} are clustering features of k-th and g-th clusters, respectively;
2.3 merging two clusters with a highest proximity as a new cluster, and updating the proximity matrix P; and
2.4 repeating Step 2.3 until a total number of the clusters is 1 or a stopping condition is reached;
(2) constructing, by adopting a multi-channel-based multi-source input fusion method, corresponding input data sets for the clusters;
wherein the multi-channel-based multi-source input fusion method includes:
3.1 reconstructing a single-user time sequence input, reconstructing a historical load sequence of a residential user over a week from a day 8 days before a time to be predicted to a previous day of the time to be predicted into a two-dimensional feature map with 7 rows and 24 columns, wherein each row corresponds to daily loads on different dates and each column corresponds to loads of different hours on different dates; and
3.2 transmitting two-dimensional feature maps corresponding to different users in a same cluster to different channels in an input of the convolutional neural network, wherein data in a single channel is a two-dimensional feature map of one user, fusing, by utilizing the channel dimension, the feature maps of the different users in the same cluster to obtain a fused feature map, and taking the fused feature map as an input of a feature sharing layer in the convolutional neural network; and
(3) establishing a multi-task-based load prediction model based on the convolutional neural network for each of the clusters, outputting, by each model, in parallel load prediction values for different users in a corresponding cluster to eventually obtain load prediction results of all of the residential users;
wherein the multi-task-based load prediction model based on the convolutional neural network is:
4.1 taking load predictions of different residential users in a same cluster as different tasks, and implementing a multi-task-based learning strategy for each cluster in assistance with learning correlations and differences among loads of the different residential users;
4.2 taking the convolutional neural network as the feature sharing layer for a multi-task-based learning to extract the correlations among different tasks; and
4.3 taking the convolutional neural network as the feature sharing layer to learn shared information representations among the different users, wherein a model for multi-task-based predicting the massive-user loads based on the multi-channel convolutional neural network mainly includes the feature sharing layer and specific task layers, a bottom portion of the feature sharing layer is formed by alternately connecting two convolutional layers with two pooling layers, and then inputting a flattened result to a fully connected layer in a top portion to extract a shared feature, and transmitting the shared feature to each of the specific task layers, wherein the specific task layers are configured to extract unique features of each of the users, and are specifically composed of a feature extraction enhancement channel, a Concatenate layer and the fully connected layer, the feature extraction enhancement channel is composed of a single fully connected layer and configured to extract features from a historical load time sequence of each of the users, to input the extracted features and the shared feature into the Concatenate layer for fusion, and the load prediction values of all of the users in the same cluster are output in parallel after processing by the fully connected layer.

8. The method of claim 7, wherein, in Step 4.1, a calculation process of a loss function in the multi-task-based learning strategy is specifically as follows:
assuming that multi-task-based learning includes V tasks in total, input and output data sets corresponding to each task being {xᵥ, yᵥ}, v=1, 2,...V, and then all of the input data sets being:
X={x₁, . . . ,xᵥ, . . . x_{V}},
defining an output of a prediction model corresponding to the v-th task is defined as:
y^{v}=u^{v}(X;θ^{sha},θ^{v}),
where u^{v} represents a mapping function of the prediction model corresponding to the v-th task, θ^{sha} is a parameter for the feature sharing layer, and Ov is a parameter for a v-th specific task layer, v=1,2, . . . V; and
conducting, by a plurality of tasks in a hard sharing mechanism, a joint learning on related tasks, and training network parameters by minimizing an overall loss function, wherein a calculation of an overall optimization loss function is as follows:
$$Loss = {\sum }_{v = 1}^{V} {α}_{v} loss ( {u}^{v} ( {θ}^{sha} , {θ}^{v} ) , {y}^{v} ) ,$$
where loss(⋅)represents a loss function of the tasks; and αᵥ is a weight coefficient corresponding to each of the tasks.

9. The method of claim 8, wherein, in Step 4.2, a calculation process of the convolutional neural network is specifically as follows:
4.2.1 conducting calculations in the convolutional layers, assuming that a number of convolution kernels in an a-th convolutional layer being C^{a}, then a set MAP^{a} of output feature maps in the layer being:
$$, {MAP}^{a} = \{ {map}_{e}^{a} \} , e = 1 , 2 , … , {C}^{a} , \\ {map}_{e}^{a} = {f}_{con} ( {\sum }_{r ∈ {C}^{a - 1}} {map}_{r}^{a - 1} * {w}_{re}^{a} + {b}_{e}^{a} ) , r = 1 , 2 , … , {C}^{a - 1} ,$$
where MAP^{a} is the set that contains all the output feature maps of the a-th layer, in a mapₑ^{a} represents an output feature map corresponding to an e-th convolution kernel in the a-th convolutional layer, mapᵣ^{a-1} represents an r-th output feature map in an (a−1)-th layer, r represents a serial number of the convolution kernel in the (a−1)-th layer, C^{a-1} is a number of the output feature maps in the (a−1)-th layer, that is, a number of channels included in input data of the a-th convolutional layer, wᵣₑ^{a} is a kernel parameter for the e-th convolution kernel in the a-th convolutional layer corresponding to the r-th output feature map in a previous layer of the a-th convolutional layer, bₑ^{a} is a bias in the a-th convolutional layer corresponding to an e-th output feature map, and f_{con}(⋅) represents an activation function in the convolutional neural network; and
4.2.2 conducting a calculation in a maximum pooling layer, which is specifically as follows:
F_{down}(mapₑ^{a})=max {pix_{e,1}^{a},pix_{e,2}^{a}, . . . ,pix_{e,n}_{ₑ}_{^{a}}^{a}}, poolₑ^{a+1}=fₚₒₒₗ(βₑ^{a+1}F_{down}(mapₑ^{a})+bₑ^{a+1}),and
e=1,2, . . . ,C^{a},
where F_{down} represents a downsampling function in the maximum pooling layer, C^{a} represents a number of channels, mapₑ^{a} represents the output feature map in the a-th convolutional layer corresponding to the e-th convolution kernel, that is, a feature map in an input of an (a+1)-th pooling layer corresponding to an e-th channel, pix_{e,z}^{a} is a z-th pixel in the feature map, z=1,2, . . . , nₑ^{a+1} is a total number of pixels corresponding to the feature map, poolₑ^{a+1} represents an output feature map in the (a+1)-th pooling layer corresponding to the e-th channel, βₑ^{a+1} and bₑ^{a+1} are a multiplicative bias and an additive bias in the output feature map, and f_{con}(⋅) is an activation function in the pooling layer.
